(19) United States
(12) Patent Application Publication
(10) Pub. No.: US 2018/0368328 A1
(43) Pub. Date: Dec. 27, 2018

(54) ENVELOPING MATERIAL FOR A BALER, AND METHOD

(71) Applicant: DEERE & COMPANY, Moline, IL (US)

(72) Inventors: PASCAL GRESSET, AUXON DESSOUS (FR); FREDERIC PERROTIN, LE TREMBLOIS (FR)

(21) Appl. No.: 16/011,694

(22) Filed: Jun. 19, 2018

(30) Foreign Application Priority Data
Jun. 27, 2017 (DE) 102017210847.9

(51) Int. Cl. A01F 15/07; B65B 11/02; B65B 41/16

(52) U.S. Cl. CPC A01F 15/0715; B65B 11/02; A01F 2015/074; A01F 2015/0745; B65B 41/16

(57) ABSTRACT

An enveloping material for enveloping a bale formed by a baler includes a piece of material disposed and wound on a supply roll. The material is configured to being fed to the baler on the supply roll. The enveloping material defines a longitudinal dimension and is subdivided along its longitudinal dimension into a plurality of separable portions.

### RELATED APPLICATIONS

This application claims priority to German Patent Application Ser. No. 102017210847.9, filed Jun. 27, 2017, the disclosure of which is hereby incorporated by reference in its entirety.

### FIELD OF THE DISCLOSURE

The present disclosure relates to an enveloping material for a baler for enveloping at least substantially the lateral surface of a bale in which the enveloping material is fed to the baler in a supply roll on which the enveloping material is wound, and also to a method for enveloping a bale with an enveloping material.

### BACKGROUND

Conventional enveloping devices are used on round balers in order to wrap a round bale formed in a pressing chamber of the round baler with an enveloping material such as, for example, a net, a film or a similar, optionally also semipermeable, breathable or water-repellent material, before said bale is discharged from the round baler after enveloping is complete and then laid on the ground or is transferred to a further device, for example, a wrapping device.

Round balers of this kind are used both in the agricultural and the industrial sectors. Corresponding agricultural balers serve, for example, to form bales of harvested material and produce frequently at least substantially round cylindrical bales from harvested material, for example, of the straw, hay, chopped material etc. Industrial balers are used in the compaction of waste, textiles or other materials, and in the pressing thereof to form bales.

Known enveloping material requires that a bale be wrapped multiple times with the enveloping material in order to ensure that the bale is completely enveloped or that the enveloping material is held securely on the bale.

### SUMMARY

If an enveloping material for enveloping at least substantially the lateral surface of a bale is subdivided, with regard to its longitudinal extent, into substantially automatically separable portions, the enveloping material no longer has to be separated by a separating device or cut off by a cutter arrangement following completion of an enveloping operation. The portions can also have a predetermined or defined length such that the quantity of enveloping material which is used for an enveloping operation can be precisely predefined. Such an enveloping material is fed to the baler in the manner of a supply roll on which the enveloping material is wound. The baler is in particular an agricultural baler for forming round cylindrical bales. The baler can also be used in the industrial sector, however, in order to form bales of paper, waste, fabric or other materials. It is furthermore conceivable for it to be a baler for producing square bales, as are used both in the agricultural and the industrial sectors.

In one embodiment, at least one predetermined tearing region is provided between the portions. Such a predetermined tearing region is configured in a simple manner as at least one perforation line. The perforation line can be introduced into the enveloping material easily and reliably in particular before the latter is wound onto the supply roll or even during the production of the enveloping material. If the predetermined tearing region or perforation line extends at least substantially across the width of the enveloping material, this favors complete separation of the portions between which the predetermined tearing region or perforation line is arranged.

If the length of the portions is greater than the circumference of the bale to be enveloped, this ensures that the bale is enveloped completely. The length can be greater than the circumference by a multiple. Enveloping is particularly economical and yet secure and durable when the length of the portions is about 1.5 times the circumference. However, it is also possible for a shorter length to be provided; usually, this should be at least slightly greater than the simple circumference.

If the portions have, in a trailing end region of each portion with respect to a delivery direction, at least one adhesive region, the latter can interact with the enveloping material already wrapped around the bale or enveloping the latter, in order to secure the enveloping material or an end region of the enveloping material. The adhesive region is ahead of a corresponding next predetermined tearing region, thereby ensuring that the adhesive region is arranged in an end region of a portion.

In particular, a folding region having a plurality of folding edges is provided in the end region. The folding region may be folded together in a state of the enveloping material wound on the supply roll and is able to unfold during unwinding from the supply roll. The at least one adhesive region or the predetermined tearing region are arranged, at least when the enveloping material is in a state wound on the supply roll, between lateral regions of the folding region which are on the inside in the folded state. In this way, the predetermined tearing region or adhesive region are located in a protected manner between lateral regions in particular in the state wound on the supply roll and are protected from the effects of environmental influences. In particular, however, the adhesive region is prevented, in the wound state of the enveloping material, from interacting undesirably with other regions of the enveloping material or of the baler or the enveloping device, in particular from sticking thereto, or from losing its adhesiveness.

It is conceivable for the adhesive region to have only one adhesive component, which can interact directly with the enveloping material in order to secure an end region of a portion wrapped around a bale or enveloping such a bale to the rest of the enveloping material or to counteract any unwrapping of the enveloping material from the bale. However, when the adhesive region has at least two adhesive components which are each held on the enveloping material by means of a further adhesive component, the second adhesive component is suitable for forming a releasable adhesive connection with the first component and an at least substantially fixed adhesive connection with the enveloping material. The adhesive components can adopt any suitable form, but they are provided at least substantially in a strip-shaped manner. The strips can in this case be provided in a continuous or interrupted manner. In particular, the adhesive region or adhesive components do not extend into a peripheral region in order to optionally counteract any interaction with or adhesion to other work equipment or component parts of the baler.

In particular, the first and second adhesive components interact such that they keep two lateral regions of the folding region closed. This is desirable when the enveloping material is in a state wound on the supply roll, such that the adhesive components prevent undesired or premature unfolding of the enveloping material.

If the predetermined tearing region is arranged within the lateral regions of the folding region, at least in a folded state of the enveloping material, this can prevent premature separation of the portions or protect the predetermined tearing region from external influences by material forming the bale. If the first and second adhesive components are arranged on different sides of the predetermined tearing region with regard to a longitudinal extent of the enveloping material, the first adhesive component can remain on the portion running ahead after the portion running ahead has been separated from the rest of the enveloping material in order to adhesively connect the end region of the portion running ahead to the enveloping material already wrapped around or enveloping the bale. This may be done in order to secure the end region thereto so as to prevent unintentional detachment. The second adhesive component can then be arranged on a starting region of the portion running behind. The second adhesive component does not in this case necessarily have to have a function, but it can contribute for example in a supporting manner toward bringing the starting region or the portion running behind into contact with the bale or toward holding it thereon in particular at the start of an enveloping operation.

A method of wrapping a bale, e.g., a round bale formed in a baler, with an enveloping material is provided in which the bale is enveloped following completion of a bale formation process with a portion of the enveloping material. Here, after the bale has been enveloped, the portion is detached automatically, in particular along a predetermined tearing region, from the rest of the enveloping material wound on the supply roll, and subsequently for an end region of the portion to stick to enveloping material already located on the bale.

In the method, a folding region of the enveloping material unfolds in particular automatically after at least partially wrapping of the bale with the portion, the folding region freeing up an adhesive region. In the process, a first adhesive component comes away from a second adhesive component and in particular, after the portion has been detached from the rest of the enveloping material, the second adhesive component forms a substantially fixed adhesive connection with enveloping material enveloping the bale.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a schematic side view of an agricultural baler with pressing means and an enveloping device,

FIG. 2 is an enlarged illustration of the enveloping device with an enveloping material wound on a supply roll during the enveloping of a bale with the enveloping material,

FIG. 3 is an illustration as per FIG. 2 toward the end of the enveloping operation, wherein the bale is already completely wrapped with enveloping material,

FIG. 4 shows an illustration as per FIGS. 2 and 3, wherein a folding region of the enveloping material is starting to unfold,

FIG. 5 is an illustration as per FIG. 4 with an almost completely unfolded folding region, and

FIG. 6 is an illustration of a starting region, arranged in a feed gap, of the enveloping material.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

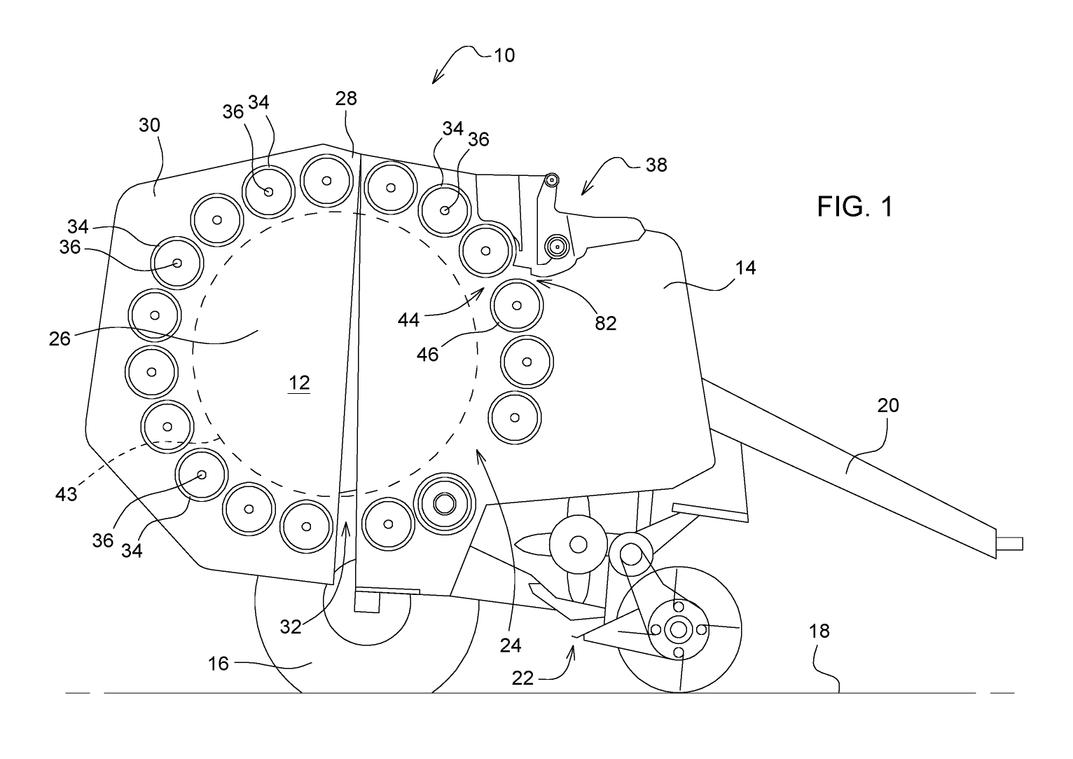

FIG. 1 shows a schematically illustrated baler 10, of the agricultural baler type for pressing a round cylindrical bale 12. The baler has a first housing part 14 which is supported on the ground 18 by means of wheels 16 and which is attachable to a towing vehicle LT (not shown), for example, a tractor, by means of a drawbar 20.

Located in a known manner on a front, with regard to a direction of forward travel, lower side of the first housing part 14 is a receiving apparatus 22 for receiving and feeding harvested material. The receiving apparatus 22 delivers cut harvested material into a pressing chamber 26 through a feed duct 24, wherein the first housing part 14 surrounds a front part of the pressing chamber 26. Located in the rear upper corner region of the first housing part 14 is a bearing 28 for a pivotable second housing part 30, which surrounds a rear part of the pressing chamber 26. In the opened state, the second housing part 30 opens up an opening 32 through which a bale 12 pressed by the baler 10 can be deposited, unloaded or ejected. The pivotable second housing part 30 can be actuated (opened and closed) by means of actuators (not shown) and thus represents an outlet flap for a bale 12 pressed in the pressing chamber 26.

According to the present embodiment, the pressing chamber 26 of the baler 10 is configured with an invariable size, and the baler 10 has a multiplicity of pressing rollers 34 that extend parallel to one another (only a few pressing rollers 34 are shown), the axes of rotation 36 of which lie on a circular arc with the second housing part 24 closed, and at least some of which are driven. In addition to pressing and shaping, the pressing rollers 34 also serve to set or keep the round bale 12 arranged in the pressing chamber 20 in rotation. The baler 10 is depicted with a slightly open rear housing part 30 to illustrate the opening 32. During a pressing operation, the rear housing part 30 is closed, however.

Furthermore, the baler 10 comprises an enveloping device 38, which is equipped with a supply roll 40 for enveloping material 42. The supply roll 40 feeds the enveloping material 42 to the pressing chamber 26 through a feed gap 44. Provided directly beneath the feed gap 44, or adjoining the latter, is a feed roll 46 which, apart from its position, is identical to the other pressing rollers 34 and can be driven in rotation therewith via a drive (not shown).

Following completion of the actual baling operation, i.e., the reception of harvested material and the formation of a bale 12 by the pressing rollers 34, travel over the ground 18 is interrupted, since the baler 10 is filled with the bale 12 and no further harvested material should or can be received in the pressing chamber 26. At this time, the enveloping device 38 is also activated, an enveloping operation following the baling operation is initiated and the enveloping material 42 is guided from the supply roll 40 through the feed gap 44 into the pressing chamber 26 and onto the bale 12. By sustained rotation of the bale 12 located in the pressing chamber 26, the enveloping material 42 is wrapped around the bale 12 such that it envelops a lateral surface 43 of the bale 12. Once the enveloping operation has been concluded, the bale 12 is deposited on the ground 18 through the opening 32 via an unloading ramp (not shown) by means of the second housing part 30 that acts in the manner of an outlet flap being opened. The baler 10 then resumes traveling and a new baling operation starts.

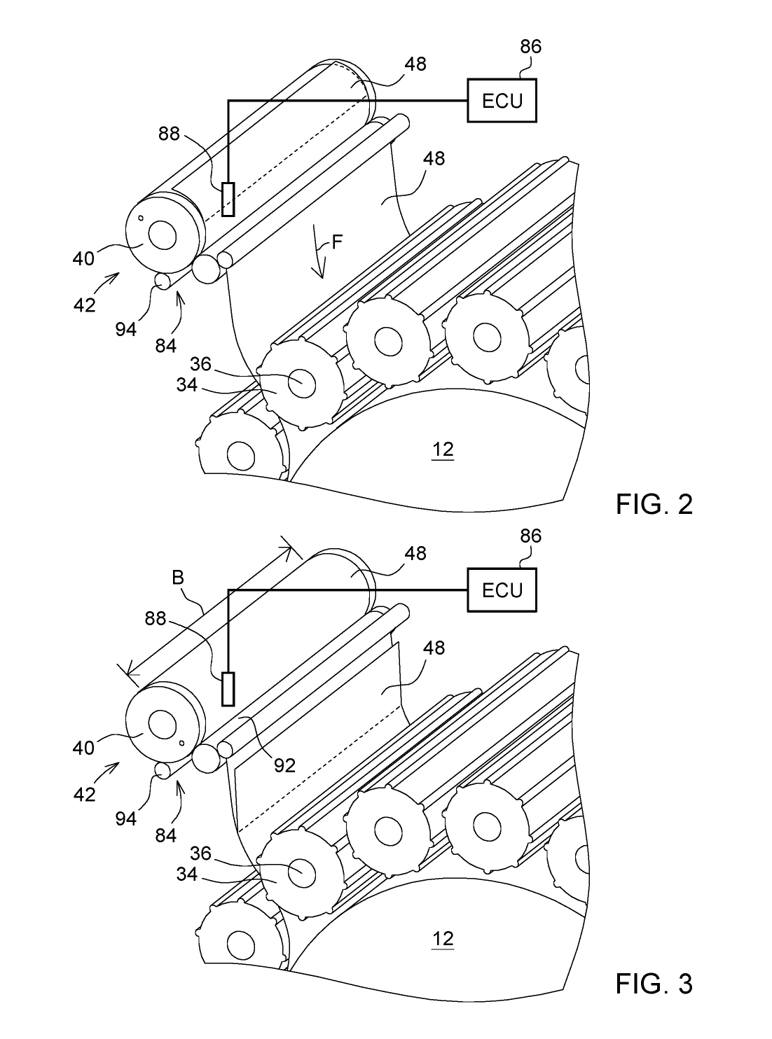

Referring to FIGS. 2-5 of the present disclosure, the enveloping device 38 and the enveloping material 42 are shown in an enlarged illustration. The enveloping device 38 is configured basically in a known manner according to the illustrated embodiment. The enveloping material 42 is fed to the feed gap 44 in this case such that it is grasped by the driven feed roll 46 and delivered in the direction of the bale 12. According to the present embodiment, the enveloping material 42 is guided at least substantially from above onto the feed roll 46, with the result that it can be grasped and entrained thereby easily (see FIG. 2).

FIGS. 3-5 show the enveloping device 38 and the enveloping material 42 now in successive phases of an enveloping operation. According to FIG. 3, the bale 12 is now almost completely enveloped with enveloping material 42 and the enveloping operation is nearly complete. Looking at the supply roll 40, it is clear that the enveloping material 42 is subdivided into portions 48 in the longitudinal direction such that in each case one portion 48 is used for enveloping a bale 12, wherein predetermined tearing regions 50 are provided between the portions 48. According to the present embodiment, these predetermined tearing regions 50 are embodied in the manner of perforation lines 52 that extend across the width B of the enveloping material 42.

Furthermore, the enveloping material 42 has folding regions 54 and adhesive regions 56, wherein the adhesive regions 56 each have two adhesive components 58, 60 configured in the manner of adhesive strips. These adhesive components 58, 60 are in turn attached to the enveloping material 42 by means of further adhesive components 62, 64 that are shown only by way of indication.

The folding regions 54 each have a first, a second and a third folding edge 66, 68, 70, which are provided one after another with respect to the delivery direction F. The first folding edge 66 is provided in an end region 71 of a portion 48 running ahead, the second folding edges 68, 70 are provided in a portion 48 running behind, wherein the adhesive region 56 and the predetermined tearing region 50 are provided between the first folding edge 66 and the second folding edge 68 and the adhesive region 56 runs ahead of the predetermined tearing region 50. The first folding edge 66 and the second folding edge 68 furthermore define a first lateral region 72 between one another and the second folding edge 68 and the third folding edge 70 define a second lateral region 74 between one another.

If the enveloping material 42 is in a state wound on the supply roll 40, the folding regions 52 are folded together such that the predetermined tearing region 50 and the adhesive region 56 are arranged between the lateral regions 72, 74, specifically such that the adhesive components 58, 60 come to rest on one another. The second adhesive component 60 is in the form of a silicone-type material which adheres only lightly to the first adhesive component 58 in the folded state of the folding region 54 such that the folding region 54 is held together by the first and second adhesive components 58, 60 in a state wound on the supply roll 40.

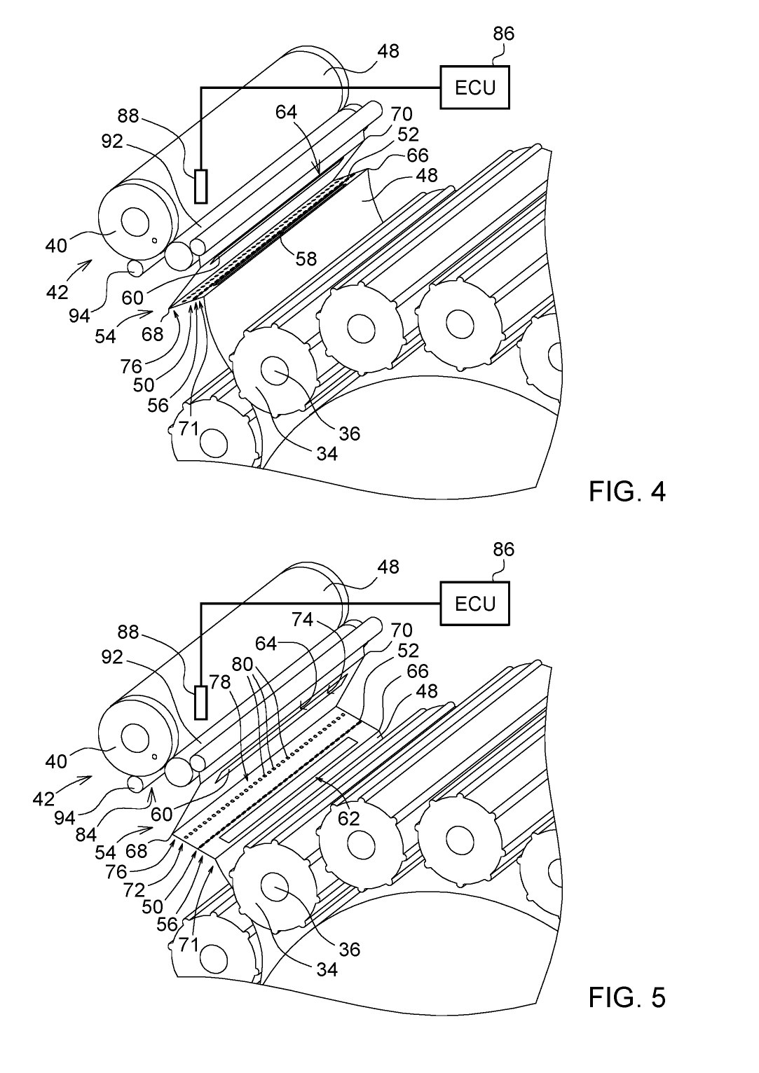

If the bale 12 has been completely wrapped with enveloping material 42, as is illustrated in FIGS. 4 and 5, the rotating bale 12 acts on the enveloping material 42 such that it exerts a force acting in the delivery direction F thereon. The force exceeds an adhesive force between the first and second adhesive components 58, 60 and unfolding the folding region 54. The first adhesive component 58 now passes into abutment with the enveloping material 42 enveloping the bale 12 and forms a firmly adhesive connection therewith.

The force applied by the rotating bale 12 now acts on the predetermined tearing region 50 and separates the portions 48 from one another along the perforation line 52. The bale 12 is now enveloped with enveloping material 42 and can be discharged from the pressing chamber 26.

The enveloping material 42 furthermore has, in a starting region 76 of each portion running behind, a row of entrainers 78 in the form of substantially round cutouts 80. The entrainers 78 extend transversely across the width B of the enveloping material 42 and adjoin, at a distance, the predetermined tearing region 50 that runs ahead with respect to the delivery direction F, and are provided in front of the second folding edge 68, or between the predetermined tearing region 50 running ahead and the second folding edge 68.

By way of the entrainers 78, the enveloping material 42, or a starting region 72 of each portion, can be grasped for example by the bale 12 or by material forming the bale 12, for example, in the case of an agricultural bale, by stalks of harvested material of the straw or hay type.

Furthermore, the row of cutouts 80 can also serve as a safety device in the event that no separation takes place along the predetermined tearing region 50 or the portion 48 enveloping the bale 12 is too short. Alternatively, separation can now take place along the cutouts 80 arranged in a row and thus wrapping of the bale 12 with a second portion 48 can be prevented.

If the enveloping device 38 has a feed device 82 (shown by way of indication in FIG. 1) for the enveloping material 42, for example, a feed lever provided in a pivotable manner on the enveloping device 38, the feed lever can interact with the entrainer 78 or engage in the or one of the cutout(s) 80 in order to guide the enveloping material 42 onto the feed roll 46 or the bale 12. Interaction of such a feed device 82 with the entrainer 78 and engagement in the or one of the cutout(s) 80 can furthermore determine the position of the enveloping material 42 or of that portion 48 of the enveloping material 42 that is grasped by the feed lever with respect to the feed device 82 and thus the enveloping device 38 or the bale 12. This can contribute toward the enveloping material 42 or the portion 48 for enveloping the bale 12 being positioned such that the length of the portion 48 that follows onto the feed device is at least substantially the same for each enveloping operation.

It should be noted here that such entrainers 78 can also be provided on conventional or known enveloping materials, or on enveloping materials that differ from the above-described enveloping material such as on films, or an above-described enveloping material 42 does not necessarily have to be provided with such entrainers 78.

Reference is now made in particular to FIGS. 2 to 6 in which a braking device 84 for an enveloping material 42 is shown. The braking device 84 can be used on an above-described enveloping device or on a conventional enveloping device or baler or in conjunction with an above-described and a conventional enveloping material, for example a net or a film.

According to the present embodiment, the braking device 84 is operatively connected to a control device 86 of the baler 10 and has a sensor 88, of the optical sensor 88 type, which can detect whether a marking 92 provided in a peripheral region 90 of the enveloping material 42 is located in a sensing region of the sensor 88.

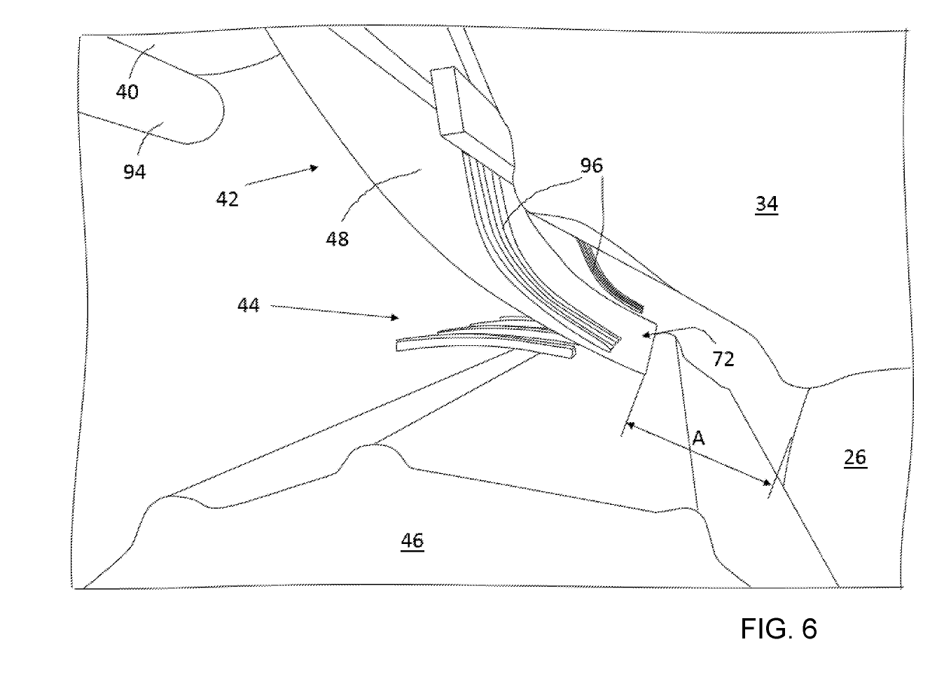

If the sensor 88 identifies that a marking 92 is present in its sensing region, it transmits this information to the control device 86, which accordingly activates the braking device 84 such that a braking means 94 of the braking device 84 is applied to the enveloping material 42 in order to brake the latter. The marking 92 is arranged on the enveloping material 42 such that it indicates to the braking device 84 that it should brake the enveloping material 42 when the starting region 72 of a portion 48 running behind a portion 48 enveloping a bale 10, or the end thereof that is now free following severing of the portion 48 enveloping the bale 10 along the predetermined tearing region 50, takes up a predetermined position (see FIG. 6). In particular, the portion 48 is braked such that its starting region 72, or its free end, is arranged in the feed gap 44 such that a distance A between the starting region 72 and the pressing chamber 26 is at least substantially the same at the start of each enveloping operation. According to the illustration in FIG. 6, the enveloping material 42, or the starting region 72, is furthermore held in abutment with the feed roll 44 by a directing means 96 which is not required for the desired action of the braking device.

In this way, the braking device 84 contributes toward each bale 10 being enveloped with an at least substantially identical quantity of enveloping material 42, or, in the case of an above-described enveloping material 42 subdivided into portions 48, or an enveloping material 42 having predetermined tearing regions 50, being enveloped with exactly one portion 48, or each portion 48 being positioned appropriately for enveloping a bale.

Alternatively, a braking device 84 can also be controlled, for example, in a temporally cyclical manner. However, it is also conceivable for a sensor means 88 to be provided which determines the length of the enveloping material 42 already drawn from the supply roll 40. The braking device 84 can also have a lever device (not shown), however, which interacts with a marking 92 of the cutout type into which a mechanical braking element in the form of a lever element provided in an articulated manner on the enveloping device 38 can engage in order to brake the enveloping material 42. After the enveloping material 42 has been separated, the braking element can pivot or be pivoted back into a starting position in which it does not act on the enveloping material 42. The braking device 84 does not necessarily have to be controlled by a control device. Provision can also be made for a drive (not shown) such as, for example, a drive of the supply roll 40 to be braked or deactivated in a corresponding manner.

The separation of the portions 48 along the predetermined tearing region 50 can take place without the aid of further auxiliaries, and without the use of a separating device or cutter arrangement. Furthermore, a force acting on the predetermined tearing region 50 can be increased or an additional force can be applied by the braking device 84 shown at the end of an enveloping operation, however.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. An enveloping material for enveloping a bale formed by a baler, comprising:
a piece of material disposed and wound on a supply roll, the material configured to being fed to the baler on the supply roll; and
the material defines a longitudinal dimension and being subdivided along its longitudinal dimension into a plurality of separable portions.

2. The enveloping material of claim 1, further comprising at least one predetermined tearing region is defined between the plurality of separable portions, the predetermined tearing region being configured as at least one perforation line extending at least substantially across a width of the enveloping material.

3. The enveloping material of claim 1, wherein a length of the separable portions is greater than a circumference of the bale to be enveloped.

4. The enveloping material of claim 3, wherein the length is about 1.5 times the circumference.

5. The enveloping material of claim 1, wherein each of the plurality of separable portions comprises a trailing end region defined with respect to a delivery direction and at least one adhesive region located ahead of a corresponding next predetermined tearing region.

6. The enveloping material of claim 5, further comprising a folding region having a plurality of folding edges provided in the end region, the folding region being folded together in a state of the enveloping material wound on the supply roll and being able to unfold during unwinding from the supply roll.

7. The enveloping material of claim 6, wherein the at least one adhesive region or the predetermined tearing region is arranged, when the enveloping material is wound on the supply roll, between lateral regions of the folding region.

8. The enveloping material of claim 7, wherein the lateral regions of the folding region are located on an inside in the folded state.

9. The enveloping material of claim 6, wherein the adhesive region comprises a first and a second strip-shaped adhesive components which are each held on the enveloping material by a further adhesive component (62, 64), the second strip-shaped adhesive component forming a releasable adhesive connection with the first strip-shaped adhesive component and a fixed adhesive connection with the enveloping material.

10. The enveloping material of claim 9, wherein the first and second strip-shaped adhesive components are configured to maintain two lateral regions of the folding region closed when the enveloping material is wound on the supply roll.

11. The enveloping material of claim 10, further comprising a predetermined tearing region arranged within the lateral regions of the folding region at least in the folded state of the enveloping material.

12. The enveloping material of claim 11, wherein the first and second adhesive components are arranged on different sides of the predetermined tearing region with regard to the longitudinal dimension of the enveloping material.

13. A method for enveloping a bale formed in a baler, comprising:
providing a supply roll of an enveloping material wound thereon, the material defining a longitudinal dimension and being subdivided along its longitudinal dimension into a plurality of separable portions;
wrapping the bale with a portion of the enveloping material;
after wrapping the bale, automatically detaching the enveloping material along a predetermined tearing region of the material from the rest of the enveloping material wound on the supply roll;
adhering an end region of the portion of enveloping material to the enveloping material already disposed on the bale.

14. The method of claim 13, further comprising automatically unfolding a folding region of the enveloping material after the wrapping step.

15. The method of claim 14, wherein the folding region releases the adhesive region.

16. The method of claim 14, further comprising detaching a first adhesive component from a second adhesive component.

17. The method of claim 16, wherein, after the portion of enveloping material is detached from the rest of the enveloping material, the first adhesive component forms a substantially fixed adhesive connection with enveloping material enveloping the bale.
